(19) United States
(12) Patent Application Publication
(10) Pub. No.: US 2005/0114340 A1
(43) Pub. Date: May 26, 2005

(54) Method, system, and storage medium for providing adaptive programming listings over a network

(76) Inventors: Nicholas S. Huslak, Duluth, GA (US); A.C. McQuaide JR., Berkeley Lake, GA (US); Sharon E. Carter, Austell, GA (US)

Correspondence Address: CANTOR COLBURN LLP, 55 GRIFFIN ROAD SOUTH, BLOOMFIELD, CT, 06002, US

(21) Appl. No.: 10/719,475

(22) Filed: Nov. 21, 2003

(51) Int. Cl. G06F 7/00

(52) U.S. Cl. 707/10

(57) ABSTRACT

Embodiments relate to a method, system, and storage medium for providing adaptive programming listings over a network. The method includes gathering available programming data from a server, storing the programming data in a database, and gathering program recommendation guides from third parties and storing the program recommendation guides in a recommendation guide database. The method also includes presenting a user interface to a customer entity along with the program recommendation guides, receiving at least one selection from the program recommendation guides, and storing the selection in a customer preference database.

### BACKGROUND OF THE INVENTION

Embodiments of the invention relate generally to audio/video content viewing activities, and more particularly, to a method, system, and storage medium for providing adaptive programming listings over a network.

Television programming customers are currently presented with a fixed interface into their provider's available on-screen programming listings from which they make choices on programs they wish to view. Many customers have strong preferences regarding the types of programming they choose to view. Further, these preferences are often expressed in program recommendation guides (e.g., ‘block’ lists or ‘allow’ lists) that are available to service providers. For example, a customer may be interested in seeing programs on the American Film Institute's™ top 100 movie list, or programs endorsed by trusted sources such as the Christian Broadcast Network. A customer may also prefer not to see any programs that a particular program recommendation guide lists as containing objectionable adult material. Currently, the only way for the customer to make a viewing decision is to manually compare their program recommendation guides with the on-screen programming list of available programs, which can be a tedious and time-consuming process.

What is needed, therefore, is a convenient and time-saving service that would allow customers to specify their viewing preferences, process the preferences against the customer's available programming, and present to the customer in on-screen programming listings only those programming titles that meet the customer's viewing criteria.

### SUMMARY OF THE INVENTION

Embodiments of the invention relate to a method, system, and storage medium for providing adaptive programming listings over a communications network. The method includes gathering available programming data from a server, storing the programming data in a database, and gathering program recommendation guides from third parties and storing the program recommendation guides in a recommendation guide database. The method also includes presenting a user interface to a customer entity along with the program recommendation guides, receiving at least one selection from the program recommendation guides, and storing the selection in a customer preference database.

Embodiments further include a system for providing adaptive programming listings over a communications network. The system includes a customer entity and a host system in communication with the customer entity via a communications network. The host system includes a server, a database of available programming data, a database of customer preferences, and a database of program recommendation guides. The system further includes a preference filtering system executing on the host system. The preference filtering system gathers available programming data from the server, stores the available programming data in the database of available programming data, gathers program recommendation guides from third parties, and stores the program recommendation guides in the database of program recommendation guides. The preference filtering system also presents a user interface to a customer entity along with the program recommendation guides, receives at least one selection from the program recommendation guides, and stores the selection in the database of customer preferences.

The preference filtering system processes the customer entity's selected program recommendation guides (stored in the customer preferences database) against the database of available programming data, and delivers the result of the processing to the customer entity whenever an on-screen programming listing is requested.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of a system upon which the preference filtering system is implemented in exemplary embodiments of the invention;

FIG. 2 is a flowchart describing the process of customizing viewer preferences and presenting selected programming material to a customer via the preference filtering system in exemplary embodiments of the invention; and

FIG. 3 is a sample user interface computer screen display on a communications device illustrating menu options available to a user for implementing the preference filtering system in exemplary embodiments of the invention.

### DETAILED DESCRIPTION OF THE INVENTION

The preference filtering system provides a means to customize the selection and subsequent viewing and/or recording of television programs by affirmatively choosing from a selection of program recommendation guides and other criteria that satisfy a viewer's personal tastes and interests. The program recommendation guides and criteria selected are used by the preference filtering system to filter out unwanted programming and present only desirable materials. The customer has the choice of either receiving the filtered program listings on a television screen or other device, or having the results automatically recorded as desired. Registration and implementation of the preference filtering system may be performed using various communications methods including telephone, email, text messaging, or other communications means.

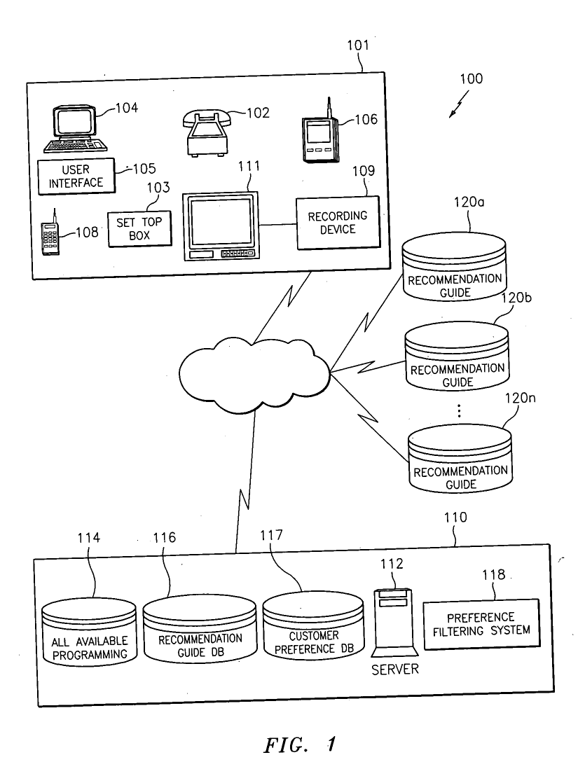

The preference filtering system is executed via a communications network as shown in the system 100 of FIG. 1. FIG. 1 depicts a customer entity 101, a host system 110, and a “communications cloud” that connects the elements of customer entity 101 and those of host system 110 using some combination of communications technologies, including cable television technology, satellite television technology, the Public Switched Telecommunications Network, mobile telecommunications networks, wireless networks, the Internet, and other telecommunications technologies. Customer entity 101 comprises a variety of communications devices with which the preference filtering system 118 may communicate. A user may establish or edit viewing preferences via one or more of communications devices 102-109. Communications devices associated with customer entity 101 include a wireline telephone 102, a personal desktop computer 104, a personal digital assistant (PDA) 106, a wireless mobile telephone 108, a set top box 103 in conjunction with television 111, and a personal recording device 109. It will be understood that other types of communications devices may also be utilized in order to realize the benefits of the invention. Set top box 103 includes controls (possibly including a wired or wireless remote control) that allow a customer to access the services provided by the preference filtering system 118 in conjunction with television set 111A customer refers to an individual that subscribes to a programming service such as a cable television service or a satellite television service. The customer receives programming from the programming service provider in accordance with a service plan (e.g., basic cable service with limited channels, extended cable with selected premium channels, etc.).

Wireline telephone 102 refers to a traditional wired telephone utilizing Public Switched Telephone Network (PSTN) that carries analog voice data.

Set top box 103 refers to a device purchased by the customer entity or provided by the service provider that communicates with external devices such as the host system 110 and is connected to the television 111. Set top box 103 may also incorporate the functionality of recording device 109.

Personal computer 104 may comprise a desktop, laptop, or other similar general-purpose computing device.

PDA 106 comprises a mobile computing device with networking capability such as a web browser and an Internet Service Provider subscription for allowing PDA 106 to communicate digitally with other communications devices.

Wireless mobile telephone 108 communicates via a cell tower and mobile switching center (not shown), which, in turn, communicates to other networks via a central office (not shown). The telecommunications infrastructure required for enabling communications devices 102-108 are well known and will be understood by those skilled in the art.

Each of the communications devices 102, 103 (in conjunction with television 111), 104, 106, and 108 in customer entity 101 includes a user interface 105 that allows the customer, via the communications device, to browse program recommendation guides and select threshold criteria and filtering options for transmission to the service provider. Note that the only the form of user interface 105 will vary from one communications device to another (e.g., voice prompts and selections via key depressions will be used on wireline telephone 105); the functionality of the user interface should not vary from cone communications device to another.

Personal recording device 109 refers to a system that communicates with television 111 and/or set top box 103 via a wireline or wireless technology, as well as with external systems such as host system 110 via a service provider network as shown. Personal recording device 109 receives instructions from a computer user on personal computer 104, from set top box 103 and/or television 111, or from host system 110 regarding which programs will be displayed on television 111 or will be recorded by personal recorder device 109. Personal recorder device 109 comprises a storage device such as an internal hard drive or DVD recording device whereby digital programming signals are received over the communications network and stored on the storage device. Personal recording device 109 may comprise a commercial product such as TiVO™ or other similar type of device. Personal recording device 109 may be incorporated in set top box 103.

Host system 110 executes the preference filtering system 118, which comprises any suitable high-speed microprocessor capable of handling the volume of activities provided by the features and functions of the preference filtering system 118 and its customer base. Server 112 is accessible to the communications network and includes a security feature or firewall (not shown) in order to protect the integrity of the data stored therein. Host system 110 may be a cable television service provider that provides the preference filtering system 118 services to existing cable customers for a fee. Server 112 further delivers programs on various channels to customers, as well as programming data relating to current and future available content presented on, or scheduled for presentment on, television 111 (possibly via set top box 113), or recorded on recording device 109.

The preference filtering system 118 may be executed by a network services provider or application service provider (ASP) and a portion of the preference filtering system 118 may be resident on a customer's communications device as described further herein.

Available programming database 114 stores a list of all available programs currently available on server 112. The programming may include broadcast programming, cable network programming, premium channel programming, and pay-per-view programming selections.

Recommendation guide database 116 stores external program recommendation guides gathered by host system 110 from external sources such as databases 120a-120n. In addition, recommendation guide database 116 may store program recommendation guides custom designed by the service provider. For example, host system 110 may evaluate available programming stored in database 114 and, using its own specified criteria, establish a list of preferred programs or a list of mature-themed programs to caution parents of young children or other programming material that the customer prefers to avoid. For example, the content may be organized by ‘rating’, such as G, PG, R, etc., and may be organized by genre or other types of classification indicia. Other classification indicia for use in creating a program recommendation guide include subject matter, genre, awards received, cast member, date of program, fiction/nonfiction status, host system preferences, and third-party source preferences.

Customer preference database 117 contains a list of program recommendation guides that have been selected by each customer. External preferences databases 120a-120n refer to programming information evaluated and rated by third parties. For example, external preferences database 120a may be associated with a web site for the American Film Institute that includes a listing of the AFI's top 100 films. Movie buffs may find such a resource to be helpful in distinguishing quality films from the sea of less than desirable movies that flood a viewer's programming guide. Another example may be where external preferences database 102b is associated with a web site for Parenting Magazine™, which frequently views and rates programming and provides these rankings to young parents who may not have time to filter out the undesirable programming. In this manner, a parent may access the program recommendation guide from database 120b via the preference filtering system 118 and select from these already-filtered program lists for their children. Program recommendation guides may comprise ‘block’ lists, which refer to possible objectionable material and/or may include ‘allow’ lists, which refer to recommended programming. Aside from film institutes and magazines as indicated above, other external preferences sources may include a religious organization, a political organization, a topical web site, a video store, or any commercial establishment. As described above with respect to database 116, these external program recommendation guides are collected by the host system 110 and stored in recommendation guide database 116.

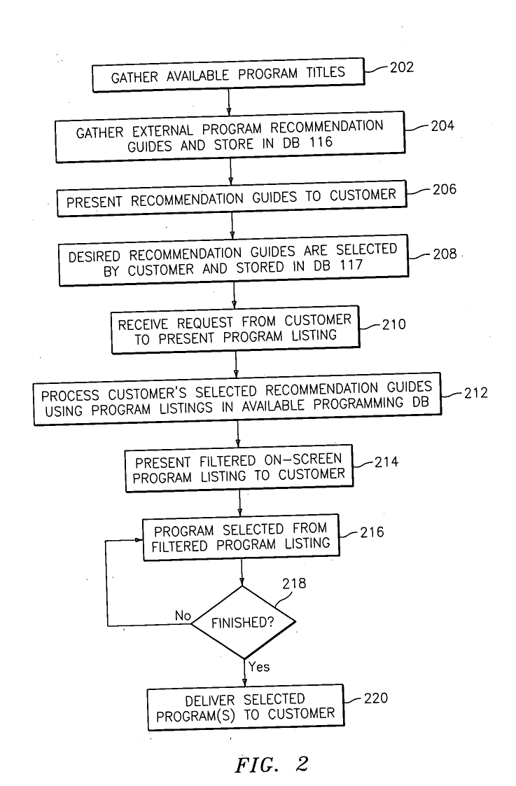

In an exemplary embodiment, the preference filtering system 118 gathers programming data and program recommendation guides from a variety of sources and presents the information to customers. The customer communicates his/her programming preferences by selecting from the program recommendation guides, the results are stored in customer preference database 117, and the preference filtering system 118 sorts through the available programming and presents only those programs that meet the customer's criteria. The customer has the option of then viewing or recording the program selection. This process is further described in FIG. 2. At step 202 all available program titles are gathered from server 112. The preference filtering system 118 then identifies and gathers any external program recommendation guides that are generated by external parties such as public interest groups, parenting organizations, religious organizations, and other types of entities at step 204. As described above, program recommendation guides may be generated by the service provider as well. External program recommendation guides generally comprise lists of highly preferred or ranked programs using guidelines established by the respective organization. These are referred to as ‘white lists’ or ‘allow lists.’ External program recommendation guides may also comprise ‘black lists’ (or ‘block lists’) that are rated unfavorably by an entity and refer to program materials that an entity recommends avoiding. The external programming recommendation guides may or may not include synopses of the programming listings contained therein. The listings may be ranked in order of preference or be provided in no order of preference. The external programming recommendation guides may also be provided to host system 110 freely, under a subscription agreement, or may be a fee-based service. These program recommendation guides are stored in recommendation guide database 116. Optional embodiments include referencing a web site provided by an external recommendation guides entity by establishing a hypertext link to the web site of the entity, rather than storing the lists in recommendation guide database 116.

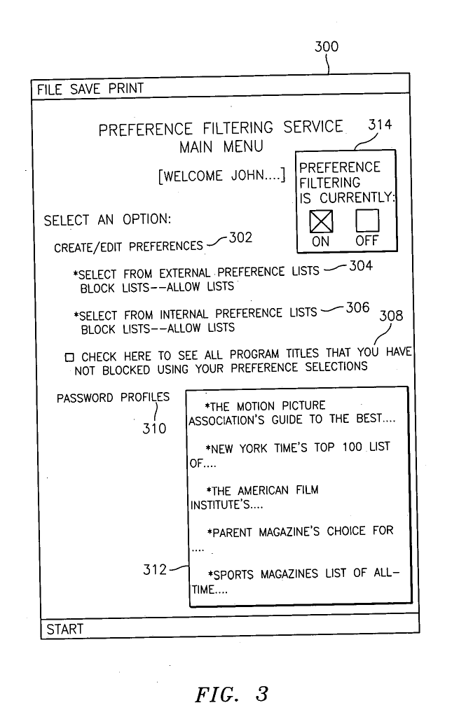

The program recommendation guides are presented to a customer using interface 105associated with one or more of the communications devices 102, 103 (in conjunction with television 111), 104, 106, and 108 represented in customer entity 101 at step 206. A sample user interface screen is shown in FIG. 3. A customer selects ‘create/edit preference’ option 302 and options 304-308 appear. In the sample user interface screen 300 of FIG. 3, the customer has selected external program recommendation guides option 304. The customer selects one or more program recommendation guides (see subwindow 312) for use by the preference filtering system 118 in screening and selecting programs at step 208. The results of this selection are stored in customer preference database 117. The customer may further indicate his/her preference for how program titles should be handled in the event that they do not appear on any of their program recommendation guides (i.e., they appear neither on “block lists” nor on “allow lists”). User interface screen 300 provides a check box 308 for this option. User interface screen 300 may also provide the ability to globally turn preference filtering on/off from the communications device supporting the user interface 105 in order to allow a user with the appropriate privileges to access titles that would have otherwise been blocked, without having to fully edit customer preferences. This option is shown at 314.

At step 210, host system 110 receives a request from a customer to display an on-screen program listing. When the request is received, the preference filtering system 118 gathers from internal and external sources (i.e., databases 116 and 120a-120n) the latest version of each program recommendation guide selected by the customer in step 208 and stored in customer preference database 117, as well as accesses the available listings from program database 114. At step 212, the preference filtering system 118 compares the program listings in the customer's selected program recommendation guides with the program listings in the available programming database 114. The preference filtering system 118 modifies the program listings for on-screen presentation according to the customer's preferences as expressed by his/her selected program recommendation guides as follows: any programs appearing on program recommendation guides as unacceptable programs are deleted from the on-screen programming list; any programs appearing on program recommendation guides as acceptable programs are allowed to remain on the on-screen programming list; and all other programs are dealt with according to the customer preferences for handling programs not covered by the previous two preference selections as selected by the customer in checkbox, 308 at step 208 above.

The host system 110 may further evaluate the customer's service plan to determine what, if any, customer preferences in programming do not coincide with the programming provided on the customer's available channel selection. For example, if a customer does not subscribe to HBO™, and a movie listing suggested by the customer's program recommendation guide shows up as an exclusive HBO™ presentation, the movie title and time may not be presented to the customer in the filtered program listing because it is not available to that particular customer for viewing. Alternative embodiments of the invention involve providing an option for the customer to affirmatively display such listings, irrespective of whether the programming is available under the customer's subscription plan. This option may serve parents of young children who do not wish that movie titles be displayed in a program listing because of objectionable wording or for similar reasons. Likewise, a customer who is considering the possibility of subscribing to a premium channel may want to have these otherwise ‘unavailable’ program listings displayed for him/her on the screen.

The result of step 212 is a refined list of programming materials (i.e., a filtered program list) that are most certain to be of interest to the customer. The filtered program list is presented to the customer at step 214. The preference filtering system 118 receives a request from a customer to view a program that is on the filtered program list at step 216. At step 218, it is determined whether the customer is finished selecting programs from the list. For example, a filtered program list may indicate that two different programs are both scheduled to air at the same time. If the customer's entertainment supports the necessary functionality, the customer may wish to view one and record the other. The customer has the option of selecting multiple programs for this purpose (resulting in a loop from step 218 to step 216). At step 220, program signals for the selections made at step 216 are delivered to the customer. As indicated above, the programming signal can be sent to the television 111 (possibly via set top box 113) for viewing or may be sent to the personal recording device 109 for recording.

Embodiments of the invention include using a customer's program recommendation guide selections as a front end to a personal recording device 109 that automatically records qualifying programs for viewing. Preference filtering system 118 includes a layered security system for implementing program selections for multiple household members with varying degrees of viewing and/or recording authority (i.e., access levels). For example, an adult household customer (i.e., master account holder) may have full access to view and select from all available program recommendation guides provided by host system 110 while a young child in the household (i.e., junior account holder) may have limited access to program recommendation guides for viewing and selecting therefrom. These access layers may be secured by the master account holder such as a parent or guardian. In this manner, a young child would be presented with a subset of available program recommendation guides and recording options. Any recording performed on behalf of a household member that exceeds the authority granted to a junior account holder would not be available for viewing or recording by the junior account holder. With a multi-user account, personal recording device 109 would use the selection results in combination, placing on its internal hard disk content that matches the least restrictive filter criterion, but tagging the content with information indicating which user has access to the content. By providing these access levels, a parent may easily preview a recorded program before deciding whether it is appropriate for a child using the extended access rights.

The preference filtering system 118 can be implemented in a variety of communications environments including, for example, a data network such as the Internet, or a voice communications network. Embodiments of the preference filtering system 118 contemplate other similar menu options as well as those depicted in FIG. 3. As indicated above, the preference filtering system 118 further allows a user to establish user preferences in programming by voice or text means. Further, it will be understood that some of the data and functionality of the preference filtering system 118 may be stored internally on communications devices 102-109 with resident memory.

The preference filtering system 118 eliminates the need for programming viewers to sift through large numbers of program listings that don't meet their personal criteria. These viewers would have access to either a focused (and optionally prioritized) list of programs they are likely to be interested in or recordings of those programs through their personal recording system. The preference filtering system 118 ensures that the viewer will not miss the opportunity to view and/or record any programs that meet all of their preferences.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

1. A method for providing adaptive programming listings over a network by a host system, comprising:
gathering available programming data from a server;
storing said programming data in a database;
gathering program recommendation guides from third parties and storing said program recommendation guides in a recommendation guide database;
presenting a user interface to a customer entity along with said program recommendation guides; and
receiving at least one selection from said program recommendation guides and storing said at least one selection in a customer preference database.

2. The method of claim 1, further comprising:
receiving a request from said customer entity for an on-screen program listing;
processing said request by comparing said at least one selection from said program recommendation guides as stored in said customer preference database to said available programming data; and
presenting a filtered on-screen program listing to said customer entity resulting from said processing.

3. The method of claim 2, further comprising performing at least one of:
transmitting a program signal to said customer entity in response to a request to view a program listed on said filtered program listing; and
automatically signaling a personal recording device to record said program on behalf of said customer entity.

4. The method of claim 1, further comprising:
generating a custom program recommendation guide by said host system using said available programming data and storing said custom program recommendation guide in said database.

5. The method of claim 2 wherein said processing said request further includes:
deleting programs appearing on said program recommendation guides of programs to avoid from said filtered on-screen program listing;
retaining any programs appearing on said program recommendation guides that contain recommended programs on said customer's filtered on-screen program listing; and
handling programs not otherwise dealt with by said program recommendation guides in accordance with instructions provided by said customer entity.

6. The method of claim 1, wherein said third parties include external sources comprising at least one of:
a film institute;
a magazine;
a religious organization;
a topical web site;
a video store; and
a commercial business.

7. The method of claim 1, wherein said customer entity comprises at least one of:
a telephone;
a mobile communications device;
a television;
a set top box;
a personal recording device; and
a personal computer.

8. The method of claim 2, wherein said presenting a filtered on-screen program listing to said customer entity resulting from said processing further includes presenting a filtered on-screen program listing in accordance with an access level granted to an account member, said access level extending or limiting access to view program listings.

9. The method of claim 3, wherein said transmitting a program signal to said customer entity in response to a request to view a program further includes transmitting said program signal in accordance with an access level granted to an account member, said access level extending or limiting access to view a program.

10. The method of claim 3, wherein said automatically signaling a personal recording device to record said program on behalf of said customer entity further includes signaling said personal recording device in accordance with an access level granted to an account member, said access level extending or limiting access to record a program or view an already recorded program.

11. A storage medium encoded with machine-readable computer program code for providing adaptive programming listings over a network, the storage medium including instructions for causing a computer to implement a method, comprising:
gathering available programming data from a server;
storing said programming data in a database;
gathering program recommendation guides from third parties and storing said program recommendation guides in a recommendation guide database;
presenting a user interface to a customer entity along with said program recommendation guides; and
receiving at least one selection from said program recommendation guides and storing said at least one selection in a customer preferences database.

12. The storage medium of claim 11, further comprising instructions for causing said computer to implement:
receiving a request from said customer entity for an on-screen program listing;
processing said request by comparing at least one selection from said program recommendation guides to said available programming data; and
presenting a filtered on-screen program listing to said customer entity resulting from said processing.

13. The storage medium of claim 12, further comprising instructions for causing said computer to perform at least one of:
transmitting a program signal to said customer entity in response to a request to view a program; and
automatically signaling a personal recording device to record said program on behalf of said customer entity.

14. The storage medium of claim 11, further comprising instructions for causing said computer to implement:
generating a program recommendation guide by said host system using said available programming data and storing said custom program recommendation guide in said recommendation guide database.

15. The storage medium of claim 12, wherein said processing said request further includes:
not presenting in on-screen guide any programs appearing on program recommendation guides of programs to avoid from said filtered on-screen program listing;
retaining any programs appearing on program recommendation guides that contain recommended programs on said customer's filtered on-screen program list; and
handling programs not otherwise dealt with by said program recommendation guides in accordance with instructions provided by said customer entity.

16. The storage medium of claim 11, wherein said third parties include external sources comprising at least one of:
a film institute;
a magazine;
a religious organization;
a topical web site;
a video store; and
a commercial business.

17. The storage medium of claim 11, wherein said customer entity comprises at least one of:
a telephone;
a mobile communications device;
a television;
a set top box;
a personal recording device; and
a personal computer.

18. The storage medium of claim 12, wherein said presenting a filtered on-screen program listing to said customer entity resulting from said processing further includes presenting a filtered on-screen program listing in accordance with an access level granted to an account member, said access level extending or limiting access to view program listings.

19. The storage medium of claim 13, wherein said transmitting a program signal to said customer entity in response to a request to view a program further includes transmitting said program signal in accordance with an access level granted to an account member, said access level extending or limiting access to view a program.

20. The storage medium of claim 13, wherein said automatically signaling a personal recording device to record said program on behalf of said customer entity further includes signaling said personal recording device in accordance with an access level granted to an account member, said access level extending or limiting access to record a program or view an already recorded program.

21. A system for providing adaptive programming listings over a network, comprising:
a customer entity;
a host system in communication with said customer entity via a communications network, said host system comprising a server, a database of available programming data, a database of customer preferences, and a database of program recommendation guides; and
a preference filtering system executing on said host system;
wherein said preference filtering system performs:
gathering available programming data from said server;
storing said available programming data in said database of available programming data;
gathering program recommendation guides from third parties and storing said program recommendation guides in said database of program recommendation guides;
presenting a user interface to a customer entity along with said program recommendation guides;
receiving at least one selection from said program recommendation guides; and
storing said at least one selection in said database of customer preferences.

22. The system of claim 21, further comprising a link to at least one external database storing a program recommendation guide.

23. The system of claim 21, wherein said customer entity comprises at least one of a:
television;
a personal recording device;
a telephone;
a set-top box;
a personal computer; and
a personal digital assistant.
